(19) United States
(12) Patent Application Publication
(10) Pub. No.: US 2013/0141239 A1
(43) Pub. Date: Jun. 6, 2013

(54) Method of Using Spring GPS Data to Supplement Location Data in a Surveillance System

(71) Applicant: Dennis M. Petricoin, JR., Hemlock, NY (US)

(72) Inventor: Dennis M. Petricoin, JR., Hemlock, NY (US)

(73) Assignees: Robert Bosch GmbH, Stuttgart (DE); Bosch Security Systems Inc., Fairport, NY (US)

(21) Appl. No.: 13/310,675

(22) Filed: Dec. 2, 2011

(51) Int. Cl. G08B 13/00

(52) U.S. Cl. 340/541

(57) ABSTRACT

A building security system includes a security sensor for sensing a security breach associated with a building. An electronic location-detecting device senses fixed geographic coordinates of the building. An electronic processor responds to a security breach sensed by the security sensor by transmitting an alarm signal to a central monitoring station. The alarm signal includes the fixed geographic coordinates of the building sensed by the location-detecting device.

### BACKGROUND

1. Field of the Invention

The patent relates to the field of surveillance systems and more particularly to surveillance systems having a fixed location.

2. Description of the Related Art

In the field of surveillance and security systems, an alarm signal is sent to a central monitoring station in the event that a security breach is detected. The security breach may be sensed human movement with a restricted area, or some emergency such as the presence of smoke. In response to receiving the alarm signal, the security system may dispatch appropriate personnel to respond to the security breach. In the case of a human intruder, police may be dispatched to the secured location. In the case of the presence of smoke, personnel from the fire department may be dispatched to the secured location. Because of the risk of loss of life and property associated with a security breach, it is desirable for the responding personnel to be dispatched quickly to and arrive quickly at the site of the security breach. In order to make this possible, accurate addresses and/or geographical coordinates should be provided to the central monitoring station. This address and/or location information is often reported by the security system that is reporting the security breach.

As described above, it is important in the field of security and protection that the central monitoring station and the dispatched personnel know the address/location of the site of the security breach. In known security systems, addresses are usually manually typed into multiple databases, and then this address information is read or transmitted to personnel (police, fire, medical, etc.) who are being dispatched to the site of the security breach, which is often the site of the surveillance and security system.

What is neither disclosed nor suggested by the prior art is a building security system that includes a location-detecting device such that the fixed geographic coordinates of the building are transmitting to a central office along with an alarm signal. Nor does the prior art disclose or suggest that such geographic coordinates may be used to verify or establish a building address at the time of installation of the security system.

### SUMMARY

The invention is directed to a surveillance system including an electronic geographic locating device, such as GPS, cellular triangulation, etc., along with mapping and reverse address look-up to provide a suggested address of the system to a central monitoring office for use by emergency personnel in locating the system in the event of a security breach. At the time of system installation, the transferred location information may be used to verify address information; propose an address; and/or identify an efficient route to the surveillance system to be used by an emergency vehicle.

In one aspect, the invention includes a building security system having a security sensor for sensing a security breach associated with a building. An electronic location-detecting device senses fixed geographic coordinates of the building. An electronic processor responds to a security breach sensed by the security sensor by transmitting an alarm signal to a central monitoring station. The alarm signal includes the fixed geographic coordinates of the building sensed by the location-detecting device.

In another aspect, the invention includes a method of installing a building security system, including installing at least one security sensor in the building. An electronic location-detecting device is provided in the building. An electronic controller is communicatively coupled to both the security sensor and the electronic location-detecting device. Fixed geographic coordinates of the building are sensed by use of the electronic location-detecting device. The controller is used to verify or establish via the Internet a building address associated with the sensed geographic coordinates.

In still another aspect, the invention includes a method of installing a building security system, including installing at least one security sensor in the building. An electronic location-detecting device is provided in the building. An electronic controller is communicatively coupled to both the security sensor and the electronic location-detecting device. Fixed geographic coordinates of the building are sensed by use of the electronic location-detecting device. The sensed geographic coordinates are transmitted to a central monitoring station. A building address associated with the sensed geographic coordinates is verified or established at the central monitoring station.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a block diagram of one embodiment of a building security arrangement of the invention;

FIG. 2 is a block diagram of another embodiment of a building security arrangement of the invention;

FIG. 3 is a flow chart of one embodiment of a method of the invention for installing a building security system; and

FIG. 4 is a flow chart of another embodiment of a method of the invention for installing a building security system.

Corresponding reference characters indicate corresponding parts throughout the several views. Although the drawings represent embodiments of the invention, the drawings are not necessarily to scale and certain features may be exaggerated in order to better illustrate and explain the invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

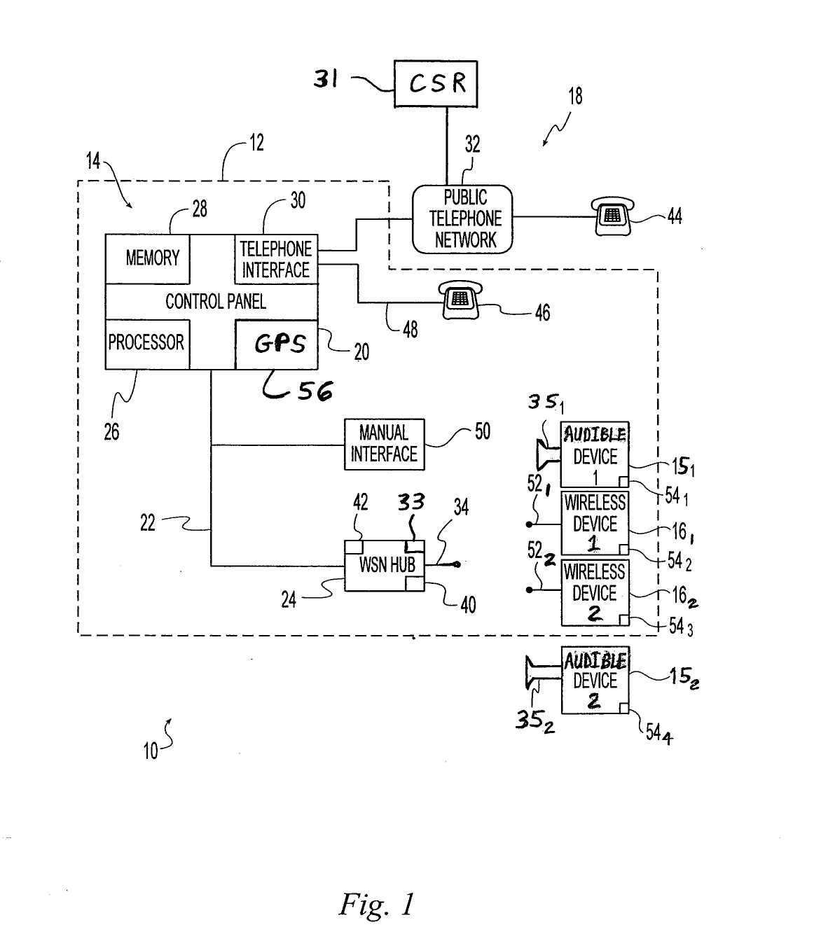

Referring now to the drawings, and particularly to FIG. 1, there is shown one embodiment of a security system 10 of the invention for a structure 12 such as a building. However, system 10 may be used to secure other spaces, such as outdoor areas, subterranean rooms and passages, and zones of air space. System 10 includes a system controller 14, audible security devices 15₁, 15₂, non-audible wireless security devices 16₁, 16₂, and an installer interface 18. Audible security devices 15₁, 15₂ may be stand alone off-the-shelf security devices which may be designed by their manufacturer to be operable independently of security system 10.

System controller 14 includes a control device in the form of a control panel 20 electrically connected via an option bus 22 to a wireless sensor network (WSN) hub 24, which also may be referred to as a “wLSN hub”. Control panel 20 may include a processor 26, a memory device 28 and a telephone interface 30. Processor 26 may coordinate communication with the various system components including installer interface 18 and WSN hub 24. Memory 28 may include software for interpreting signals from audible devices 15, wireless devices 16 and installer interface 18, and deciding based thereon whether to transmit an alarm signal from control panel 20. Memory 28 may also serve as a database for audible devices 15 and wireless devices 16. The alarm signal may be used to activate an audible alarm (not shown) within building 12, or to notify a central monitoring station or “central station receiver” (CSR) 31 such as a security company, fire station, or police station, for example, via public switched telephone network 32. Network 32 may otherwise be known as the network of the world's circuit-switched telephone networks. Memory 28 may also store identification information and configuration data for audible devices 15 and/or wireless devices 16, as described in more detail below.

WSN hub 24 may include a sound detector which may be in the form of a microphone 33 for receiving air-borne audible signals, such as audible alarm signals. The audible alarm signals may be transmitted from speakers or sirens 35₁, 35₂ of audible devices 15. Information from audible devices 15 may be passed by WSN hub 24 to control panel 20 via option bus 22. Control panel 20 may pass information to WSN hub 24 via option bus 22. WSN hub 24 may include a processor 40 and memory 42 for storing software, identification information associated with audible devices 15, and configuration data associated with audible devices 15.

WSN hub 24 may include an antenna element 34 for transmitting and receiving air-borne signals, such as radio frequency signals. The radio frequency signals may be received by and transmitted from, i.e., exchanged with, wireless devices 16. Information from wireless devices 16 may be passed by WSN hub 24 to control panel 20 via option bus 22. Control panel 20 may pass information to WSN hub 24 via option bus 22 for transmission to wireless devices 16 as necessary. WSN hub 24 may include a processor 40 and memory 42 for storing software, identification information associated with wireless devices 16, and configuration data associated with wireless devices 16.

Installer interface 18 may include an outside communication device 44, such as a cell phone, standard phone, or computer equipped with a modem; a house phone 46, which may be hard-wired to telephone interface 30 via a telephone line 48; and a manual interface 50, which may be in the form of a keypad. Manual interface 50 may be in communication with control panel 20 and WSN hub 24 via option bus 22. Thus, installer interface 18 may be in communication with system controller 14 via public telephone network 32, telephone line 48, and/or option bus 22. Installer interfaces including Ethernet or a networked connection are also possible.

Although only two audible devices 15 are shown in FIG. 1, it is to be understood that security system 10 may include any number of audible devices 15. Audible devices 15 may be in the form of any number or combination of smoke detectors, freezer thaw alarms, heavy equipment back-up warning devices, keyfobs including panic buttons, and any other devices that produce an audible alarm signal. Audible device 15₁ is indicated in FIG. 1 as being disposed inside building 12, and audible device 15₂ is indicated in FIG. 1 as being disposed outside building 12. However, any number of audible devices 15 may be disposed within building 12, and any number of audible devices 15 may be disposed outside building 12. Types of audible devices that may be permanently or temporarily disposed outside of building 12 during installation may include heavy equipment back-up warning devices and panic devices.

Although only two wireless devices 16 are shown in FIG. 1, it is to be understood that security system 10 may include any number of wireless devices 16. Wireless devices 16 may be in the form of any number or combination of window sensors, door sensors, glass break sensors, inertia sensors, motion detectors, smoke detectors, panic devices, gas detectors and keyfobs, for example. Window sensors and door sensors may detect the opening and/or closing of a corresponding window or door, respectively. Panic devices may be in the form of devices that human users keep on their person, and that are to be used to summon help in an emergency situation. Gas detectors may sense the presence of a harmful gas such as carbon monoxide, or carbon dioxide. A keyfob may be used to arm or disarm security system 10, and is another device that a user may possibly keep on his person. Each wireless device 16 includes a respective antenna element 52 for transmitting and receiving air-borne signals, such as radio frequency signals. The radio frequency signals may be received by and transmitted from, i.e., exchanged with, WSN hub 24. Wireless devices 16₁ and 16₂ are indicated in FIG. 1 as being disposed inside building 12. However, any number of wireless devices 16 may be disposed within building 12, and any number of wireless devices 16 may be disposed outside building 12. Types of wireless devices that may be permanently or temporarily disposed outside of building 12 during installation may include motion detectors, panic devices and keyfobs.

According to the invention, control panel 20 also includes an electronic location-detecting device in the form of a global positioning system (GPS) device 56. GPS 56 may sense fixed geographic coordinates of its current location, which in this case are the geographic coordinates of building 12.

During installation, some types of audible devices 15 may be mounted or hung in a permanent or semi-permanent desired location. Examples of such types of audible devices 15 may include smoke detectors and freezer thaw alarms. Other types of audible devices 15 may be disposed in temporary locations during installation, or may even be in motion, such as a heavy equipment back-up warning device or a panic device or keyfob being carried on a user's person.

During installation, some types of wireless devices 16 may also be mounted or hung in a permanent or semi-permanent desired location. Examples of such types of wireless devices 16 may include window sensors, door sensors, glass break sensors, inertia sensors, motion detectors, smoke detectors, and gas detectors. Other types of wireless devices 16 may be disposed in temporary locations during installation, or may even be in motion, such as a panic device or keyfob being carried on a user's person.

During installation, the audible security devices 15 may be learned after a discover mode has been entered by actuating certain keys on the control panel. In the discover mode, hub 24 may be instructed to “discover” audible devices 15 and wireless devices 16 that need to be installed in system 10. Discovering an audible device may include actuating a test button on the audible device in order to cause the audible device to emit its audible alarm signal. Hub 24 may then use its sound detector 33 to determine audio characteristics of the alarm signal, such as its frequency profile and loudness, for example. The installer may use manual interface 50 to enter identifying information about the audible device that emits the alarm signal, such as the type of audible device, an identification number, and/or a location of the audible device. The audible device's identifying information may then be stored in memory 28 in association with the audible device's audio characteristics.

Discovering a wireless device 16 may involve two-way communication between hub 24 and the wireless device. More particularly, discovering a wireless device 16 may include receiving, assigning, or otherwise ascertaining unique identification information and configuration data for that device, such as an identification number, a type of the device, time periods when the device is on and off, supervision intervals (i.e., how often the device should report its status), operational parameters based upon the regulations in which the system is to operate, and/or a function of the device.

In a learn mode of operation, system controller 14 issues an air-borne signal requesting that each wireless device 16 that receives the request reply with an identification number and the type of the device. System controller 14 may store each identification number and its associated type in memory 28 for further reference. The identification number may be any string of alphanumeric characters and/or bits that uniquely identifies the wireless device with which the identification information is associated. This identification number may be included within any signal transmitted from a wireless device, both during installation and during surveillance operation of system 10, in order to identify which of wireless devices 16 that the signal is being transmitted from.

The device type information may specify whether the wireless device is a window sensor, door sensor, glass break sensor, inertia sensor, motion detector, smoke detector, gas detector, panic device or keyfob, for example. The device type information may further break down these categories by subcategories such as indoor or outdoor motion detector, garage door or front door sensor, carbon monoxide or carbon dioxide, etc.

Upon receiving the unique identifier of a device 15, 16, system controller 14 may look up the device's type, which may be stored in memory 28 or may be accessed on-line via the internet. Based on the device type, system controller 14 may make some assumptions about how the device should be configured, as discussed above. System controller 14 then may monitor the device dependent upon the type of the device. As used herein, the term “monitoring” may include supervising the security devices, such as by sending instruction signals to the security devices. The term “monitoring” may also include processing reporting signals from the security devices and deciding what action should be taken in response to the reporting signals. For example, system controller 14 may cause an alarm to issue depending upon both a reported change of status of the security device, and how the device has been configured.

Upon the completion of testing, system 10 may enter an operational mode in which system 10 performs its intended function of providing surveillance. In the operational mode, wireless devices 16 continue to report their statuses according to and dependent upon their configurations, and system controller 14 continues to monitor devices 15, 16 according to and dependent upon the configurations of devices 15, 16.

Each audible device 15 and wireless device 16 may be provided with an LED 54 that may light up or flash to indicate to the installer that the device is transmitting, or has recently transmitted, some type of signal. If the LED does not light up or flash at the desired device, then the installer may need to perform some troubleshooting. For example, the installer may check the battery (not shown) of the device or replace the device with another one.

There may be an occasion when the default configuration that control system 14 has assigned to a device 15, 16 needs to be changed to suit a particular application. In order to modify the configuration of a device, a user may access manual interface 50 and key in replacement configuration data for the device.

During use, one of audible devices 15₁, 15₂ may sense an alarm condition and respond thereto by emitting an audible alarm signal. Sound detector 33 receives and detects the audible alarm and processor 26 recognizes the sound as an alarm signal by virtue of its sound characteristics, such as frequency profile and/or loudness. In one embodiment, processor 26 may determine which of audible devices 15₁, 15₂ has emitted the audible alarm signal by analyzing the sound's identifying characteristics. If, for example, processor 26 determines that an audible device in the form of a smoke detector is emitting the sound, then this identification may be forwarded to CSR 31 such that the proper authorities, e.g., the local fire department, may be notified to respond to the alarm.

The geographic coordinates of building 12 as determined by GPS 56 may be useful in directing the proper authorities to the proper location in the event of an alarm. In one embodiment, during installation, GPS 56 determines its geographical coordinates after it has been carried into building 12 by the installer. The installer may direct GPS 56 to determine its geographical coordinates by entering a command into a dedicated user interface of GPS 56. Alternatively, the installer may direct GPS 56 to determine its geographical coordinates by entering a command into manual interface 50.

In one embodiment, during installation, control panel 20 transmits a signal to CSR 31 informing CSR 31 of the geographical coordinates determined by GPS 56. CSR 31 then may determine a street address of building 12 based on the geographical coordinates, perhaps by reference to an Internet web site. The street address may conventionally include a street number, an address number, a city, and possibly a state and zip code. In the event of an alarm signal from control panel 20, CSR 31 may transmit the geographical coordinates and/or the street address of building 12 to the responding authorities, such as police, fire department, etc. The responding authorities may then use the geographical coordinates and/or the street address to plan a quick route to building 12.

In another embodiment, during installation, control panel 20 uses the geographical coordinates determined by GPS 56 to verify, establish and/or determine a street address of building 12, perhaps by reference to an Internet web site. The street address may conventionally include a street number, an address number, a city, and possibly a state and zip code. Control panel 20 then may transmit the street address to CSR 31. In the event of a subsequent alarm signal from control panel 20, CSR 31 may transmit the street address of building 12 to the responding authorities, such as police, fire department, etc. The responding authorities may then use the street address to plan a quick route to building 12.

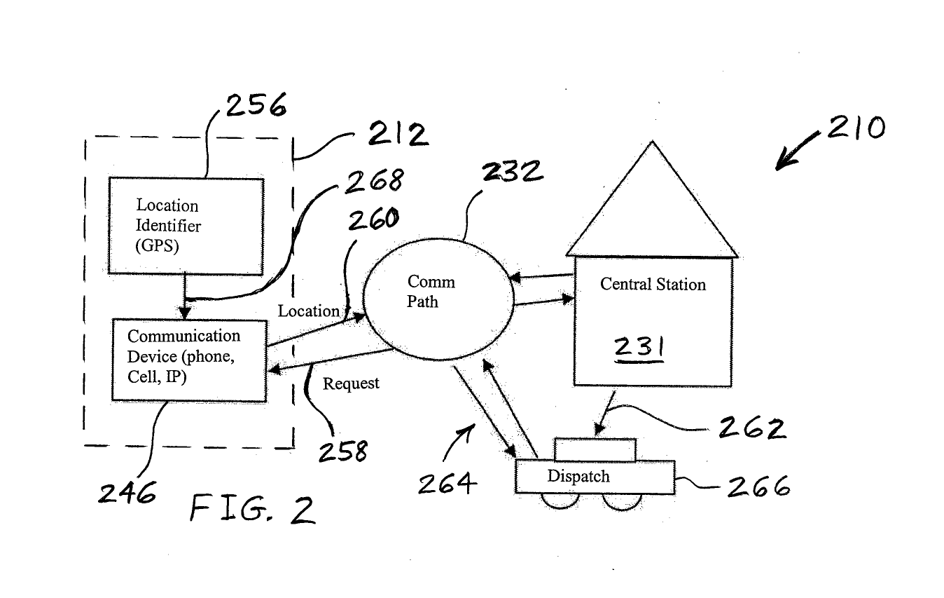

In FIG. 2 there is shown another embodiment of a security system 210 of the invention for a structure 212 such as a building. However, system 210 may be used to secure other spaces, such as outdoor areas, subterranean rooms and passages, and zones of air space. System 210 includes a location identifier 256 and a communication device 246, both of which may be disposed inside building 212. Location identifier 256 may be a GPS device that determines geographical coordinates of its current location and transmits the geographical coordinates to communication device 246. Communication device 246 may be a telephone, cellular phone, or computer connected to the Internet, for example. Communication device 246 may be communicatively coupled to a central monitoring station 231 via a communication conduit or path 232. Communication path 232 may be a public telephone network, a cellular communication network, or the Internet, for example.

During installation, central station 231 may transmit to communication device 246 a request, as indicated at 258, for the geographical coordinates of building 212. After receiving the geographical coordinates from location identifier 256, communication device 246 may transmit the geographical coordinates to central station 231 via communication path 232, as indicated at 260. Central station 231 may then determine the street address corresponding to the geographical coordinates received from communication device 246. For example, central station 231 may refer to an online database to thereby find a street address corresponding to the geographical coordinates.

Location identifier 256 and communication device 246 may be connected to a security system associated with building 212, similarly to security system 12 associated with building 12 in FIG. 1. At a subsequent point in time when the security system detects a security breach, the security system may transmit an alarm signal to central station 231 via communication device 246 and communication path 232. Upon receiving the alarm signal from communication device 246, central station 231 may retrieve the street address previously determined from the geographical coordinates received from communication device 246. Central station 231 may then transmit the street address, and possibly the geographical coordinates, to proper authorities (e.g., police, fire department, hospital), and thereby may dispatch the authorities to the location of building 212, as indicated at 262. That is, if a smoke alarm-type of alarm signal is received from communication device 246 by central station 231, then central station 231 may dispatch the fire department to the street address; if a motion detector-type of alarm signal is received, then central station 231 may dispatch the police department to the street address; and if a medical emergency-type of alarm signal is received, then central station 231 may dispatch an ambulance from the hospital to the street address.

In one embodiment, the dispatched authorities may engage en route in two-way communicate with communication device 246 via communication path 232, as indicated at 264. For example, a dispatched vehicle 266 may confirm with communication device 246 the geographical coordinates and/or street address of building 212. Dispatched vehicle 266 may also receive updated information from communication device 246, such as updated sensor signals from the security system. Such updated sensor signals may include which sensor sensed the original security breach and that sensor's location within building 212; which other sensors have sensed subsequent security breaches and the locations of those sensors within building 212; and the real-time temperatures received from various temperature sensors within building 212 and the locations of those temperature sensors within building 212, for example.

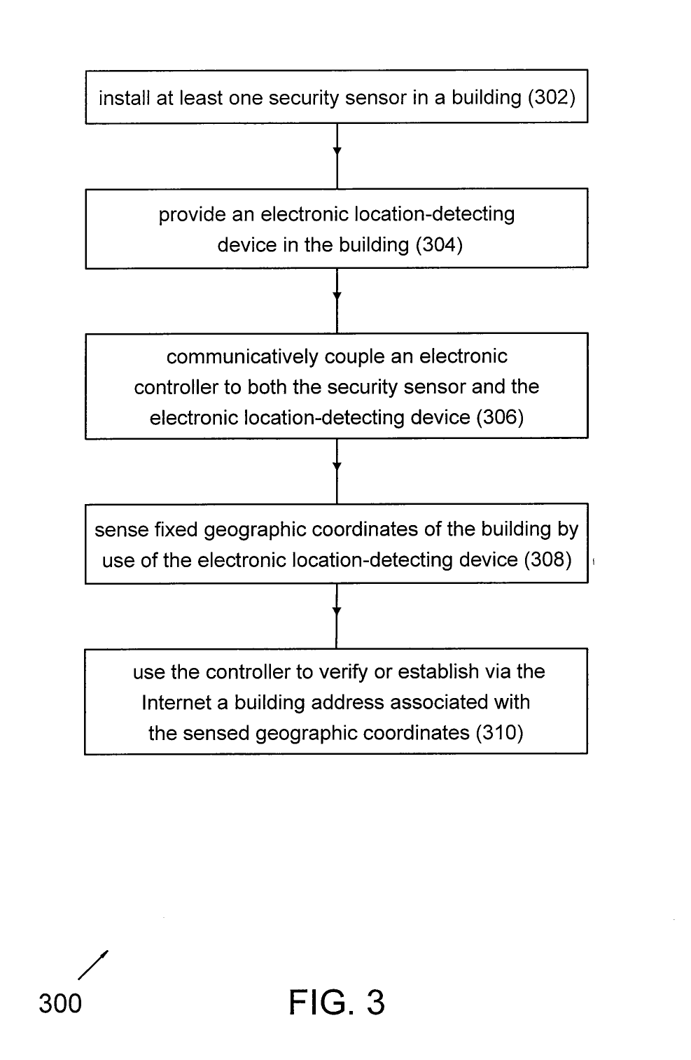

One embodiment of a method 300 of the invention for installing a building security system is illustrated in FIG. 3. In a first step 302, at least one security sensor is installed in a building. For example, audible sensor devices 15₁, 15₂ and/or wireless sensor devices 16₁, 16₂ are installed in building 12.

In a next step 304, an electronic location-detecting device is provided in the building. For example, a GPS device 56 may be provided in building 12 as part of control panel 20. In another embodiment, an installer of security system 10 may carry the GPS device into the building temporarily just for the purpose of determining the geographical coordinates of system 10, and the installer may take the GPS device with him when the security system installation is complete.

Next, in step 306, an electronic controller is communicatively coupled to both the security sensor and to the electronic location-detecting device. In the embodiment of FIG. 1, for example, processor 26 is communicatively coupled to audible sensor devices 15₁, 15₂ and/or wireless sensor devices 16₁, 16₂ via WSN hub 24. Processor 26 is also communicatively coupled to GPS 56 within control panel 20.

In step 308, fixed geographic coordinates of the building are sensed by use of the electronic location-detecting device. That is, once GPS 56 is carried into building 12, the installer may command GPS 56, either via manual interface 50 or via a dedicated user interface of GPS 56, to determine the geographical coordinates of building 12.

In a final step 310, the controller is used to verify or establish via the Internet a building address associated with the sensed geographic coordinates. For example, processor 26 may determine via public telephone network 32 and the Internet the street address of building 12 that corresponds to the geographic coordinates determined by GPS 56. In one embodiment, once the street address of building 12 has been verified or established by processor 26, control panel 20 transmits the street address to the off-site CSR 31 along with some identification information for control panel 20. Accordingly, when control panel 20 later transmits an alarm signal to CSR 31 along with its identification information, CSR 31 already has at its disposal the street address of building 12. CSR 31 may then include the street address of building 12 in the information transmitted to responding authorities when CSR 31 dispatches the authorities to building 12 in response to the alarm signal.

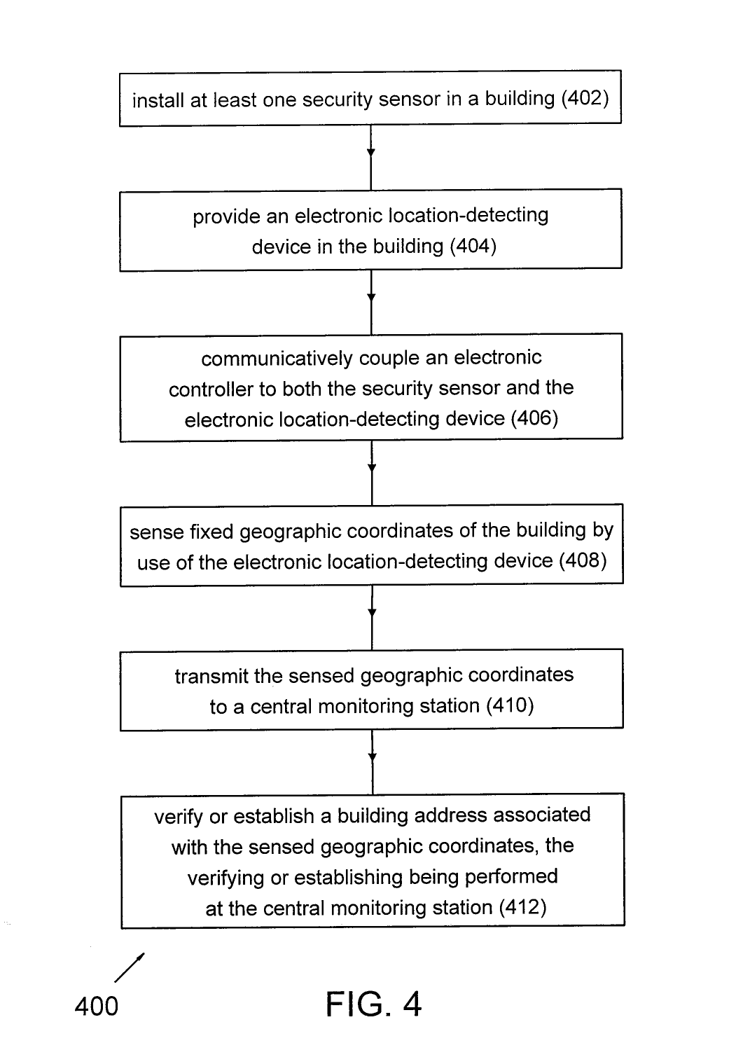

Another embodiment of a method 400 of the invention for installing a building security system is illustrated in FIG. 4. In a first step 402, at least one security sensor is installed in a building. For example, sensors similar to audible sensor devices 15₁, 15₂ and/or wireless sensor devices 16₁, 16₂ may be installed in building 212.

In a next step 404, an electronic location-detecting device is provided in the building. For example, a location identifier 256 including a GPS device may be provided in building 212. In another embodiment, an installer of the security system may carry the GPS device into the building temporarily just for the purpose of determining the geographical coordinates of the security system, and the installer may take the GPS device with him when the security system installation is complete.

Next, in step 406, an electronic controller is communicatively coupled to both the security sensor and to the electronic location-detecting device. In the embodiment of FIG. 2, for example, a processor within communication device 246 is communicatively coupled to sensors of the security system of building 212. The processor within communication device 246 is also communicatively coupled to location identifier 256, as indicated at 268.

In step 408, fixed geographic coordinates of the building are sensed by use of the electronic location-detecting device. That is, once location identifier 256 is carried into building 212, the installer may command location identifier 256, either via a manual interface of the security system or via a dedicated user interface of location identifier 256, to determine the geographical coordinates of building 212.

In a next step 410, the sensed geographic coordinates are transmitted to a central monitoring station. For example, the geographic coordinates sensed by location identifier 256 may be transmitted by communication device 246 to central station 231 via communication path 232.

In a final step 412, the building address associated with the sensed geographic coordinates are verified or established at the central monitoring station. For example, central station 231 may determine online via the Internet the street address of building 212 that corresponds to the geographic coordinates determined by location identifier 256. Accordingly, when communication device 246 later transmits an alarm signal to central station 231 along with its identification information, central station 231 already has at its disposal the street address of building 212. Central station 231 may then include the street address of building 212 in the information transmitted to responding authorities when central station 231 dispatches vehicle 266 to building 212 in response to the alarm signal from communication device 246.

While this invention has been described as having an exemplary design, the invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A building security system comprising:
a security sensor configured to sense a security breach associated with a building;
an electronic location-detecting device configured to sense fixed geographic coordinates of the building; and
an electronic processor configured to respond to a security breach sensed by the security sensor by transmitting an alarm signal to a central monitoring station, the alarm signal including the fixed geographic coordinates of the building sensed by the location-detecting device.

2. The system of claim 1 wherein the electronic location-detecting device comprises a GPS device.

3. The system of claim 1 wherein the security sensor comprises a window sensor, door sensor, glass break sensor, inertia sensor, motion detector, smoke detector, panic device, gas detector, smoke detector, freezer thaw alarm, heavy equipment back-up warning device and/or a keyfob.

4. The system of claim 1 wherein the processor is configured to receive the fixed geographic coordinates of the building sensed by the location-detecting device during installation of the system.

5. The system of claim 4 wherein the location-detecting device comprises a portable location-detecting device configured to sense the fixed geographic coordinates of the building during installation of the system, the system being configured such that the portable location-detecting device may be removed after installation of the system and before operation of the system.

6. The system of claim 1, wherein the processor is configured to communicate in real time with an emergency vehicle dispatched by the central monitoring station.

7. The system of claim 6 wherein the processor is configured to transmit updated and/or current sensor reading signals from the sensor in real time to the emergency vehicle.

8. A method of installing a building security system, comprising the steps of:
installing at least one security sensor in a building;
providing an electronic location-detecting device in the building;
communicatively coupling an electronic controller to both the security sensor and the electronic location-detecting device;
sensing fixed geographic coordinates of the building by use of the electronic location-detecting device; and
using the controller to verify or establish via the Internet a building address associated with the sensed geographic coordinates.

9. The method of claim 8 comprising the further step of transmitting the verified or established building address to a central monitoring station.

10. The method of claim 8 comprising the further step of transmitting the sensed geographic coordinates to the central monitoring station.

11. The method of claim 8 comprising the further step of using the processor to receive the fixed geographic coordinates of the building sensed by the location-detecting device during installation of the system.

12. The method of claim 8 wherein the location-detecting device comprises a portable location-detecting device, the sensing step being performed during installation of the system, the method comprising the further step of removing the portable location-detecting device from the system after installation of the system and before operation of the system.

13. The method of claim 8 comprising the further step of using the processor to communicate in real time with an emergency vehicle dispatched by the central monitoring station.

14. The method of claim 13 comprising the further step of using the processor to transmit updated and/or current sensor reading signals from the sensor in real time to the emergency vehicle.

15. A method of installing a building security system, comprising the steps of:
installing at least one security sensor in a building;
providing an electronic location-detecting device in the building;
communicatively coupling an electronic controller to both the security sensor and the electronic location-detecting device;
sensing fixed geographic coordinates of the building by use of the electronic location-detecting device;
transmitting the sensed geographic coordinates to a central monitoring station; and
verifying or establishing a building address associated with the sensed geographic coordinates, the verifying or establishing step being performed at the central monitoring station.

16. The method of claim 15 comprising the further steps of:
sensing a security breach at the building by use of the security sensor;
in response to the sensing step, transmitting an alarm signal from the security system to the central monitoring station; and
in response to the alarm signal, dispatching emergency personnel to the verified or established building address, the dispatching being performed at the central monitoring station.

17. The method of claim 16 wherein the alarm signal transmitted from the security system to the central monitoring station includes the fixed geographic coordinates of the building sensed by the location-detecting device.

18. The method of claim 15 wherein the processor is used to receive the fixed geographic coordinates of the building sensed by the location-detecting device during installation of the system.

19. The method of claim 15 wherein the location-detecting device comprises a portable location-detecting device, the sensing step being performed during installation of the system, the method comprising the further step of removing the portable location-detecting device from the system after installation of the system and before operation of the system.

20. The method of claim 15 comprising the further step of using the processor to transmit updated and/or current sensor reading signals from the sensor in real time to the emergency vehicle.
